(19) United States
(12) Patent Application Publication
(10) Pub. No.: US 2004/0243787 A1
(43) Pub. Date: Dec. 2, 2004

(54) Instruction form execution apparatus, instruction form management apparatus, instruction form management system, instruction form, and instruction form execution method

(75) Inventors: Akira Hirose, Kawasaki-shi (JP); Tomonari Yamauchi, Kawasaki-shi (JP); Yasuo Tanaka, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/806,127

(22) Filed: Mar. 23, 2004

(30) Foreign Application Priority Data
Mar. 24, 2003 (JP) 2003-081198

(51) Int. Cl. G06F 15/76

(52) U.S. Cl. 712/1

(57) ABSTRACT

An instruction form execution apparatus includes an instruction form input part that inputs an instruction form to indicate execution of a process, an execution part that executes the process indicated in the instruction form, and a deletion part that deletes the instruction form when the execution part completes the execution of the process indicated in the instruction form.

### BACKGROUND OF THE INVENTION

1. Field of the Invention

This invention relates to an instruction form execution apparatus, an instruction form management apparatus, an instruction form management system, an instruction form, and an instruction form execution method, and more particularly relates to an instruction form execution apparatus for executing the process indicated in an instruction form, an instruction form management apparatus for managing an instruction form, an instruction form management system including the instruction form execution apparatus and the instruction form management apparatus, an instruction form for indicating the process that is executed by the instruction form execution apparatus, and an instruction form execution method for executing the process indicated in the instruction form.

2. Description of the Related Art

When a user operates a personal computer for processing, it is convenient for the user to complete all processes with one indication. However, it is not convenient for the user to execute processes step-by-step. For example, when a user (1) downloads a file from a network, (2) converts the format of the file to a different format, (3) and transmits it to a PDA that can use only the file of the converted format, the user must indicates to a personal computer to execute the (1) process at first, indicates to the personal computer to execute the (2) process at second after confirming completion of the (1) process, and then indicates to the personal computer to execute the (3) process at third after confirming completion of the (2) process. In other words, the user must execute the (1) to (3) processes separately, and the increased number of processes results in a heavy burden on a user and long waiting time.

To reduce such a burden on a user and waiting time, an instruction form for indicating the process to be executed by a computer is used. According to this technique, a user forms an instruction form that indicates execution of the processes (1) to (3), and as the result the use of the instruction form allows the user to execute all the processes indicated in the instruction form with one presentation of the instruction to a computer. One presentation of the instruction to the computer is sufficient for the computer to execute all the processes (1) to (3).

If the process indicated in an instruction form is the process to be executed plural times, it is preferable that the formed instruction form is held. However, if the process indicated in an instruction form is the process to be executed only once, it is not preferable that the formed instruction form is held. Holding of an instruction form for indicating the process that is to be executed once causes the tight memory capacity and leads to misuse of the instruction form, and can cause repeated execution of the process that is intended to be executed only once.

### SUMMARY OF THE INVENTION

To address the above problem, an aspect of the present invention provides an instruction form execution apparatus including an instruction form input part that inputs an instruction form to indicate execution of a process, an execution part that executes the process indicated in the instruction form, and a deletion part that deletes the instruction form when the execution part completes the execution of the process indicated in the instruction form.

According to another aspect of the present invention, an instruction form management apparatus includes an input part that inputs an instruction form that indicates a process to be executed by at least one instruction form execution apparatus, an output part that outputs the instruction form to any one of the instruction form execution apparatuses, and a deletion part that deletes the instruction form when the instruction form is input from any one of the instruction form execution apparatuses by the input part and the process indicated in the instruction form has been completed.

According to another aspect of the present invention, an instruction form management system includes an instruction form execution apparatus and an instruction form management apparatus, wherein the instruction form management apparatus includes an input part that inputs an instruction form that indicates a process to be executed by at least one of the instruction form execution apparatuses, and an output part that outputs the instruction form to one of the instruction form execution apparatuses.

According to another aspect of the present invention, an instruction form management system includes an instruction form management apparatus and an instruction form execution apparatus, wherein the instruction form execution apparatus includes an instruction form input part that inputs the instruction form output from the output part, an execution part that executes an instruction indicated in the instruction form, and an instruction form output part that outputs the instruction form when execution of the instruction indicated in the instruction form is completed.

According to another aspect of the present invention, an instruction form has an execution instruction that indicates a process to be executed by an instruction form execution apparatus and a deletion instruction, wherein the deletion instruction indicates an instruction to delete the instruction form when the execution of the process indicated in the execution instruction is completed by the instruction form execution apparatus.

According to another aspect of the present invention, an instruction form execution method includes the steps of inputting an instruction form that indicating execution of a process, executing the process indicated in the instruction form, and deleting the instruction form when the execution of the process indicated in the instruction form is completed.

### BRIEF DESCRIPTION OF THE DRAWINGS

The present invention will be described in detail based on the followings, wherein:

FIG. 1 shows a structural block diagram of an instruction form execution apparatus used in the first embodiment of the present invention:

FIG. 2 shows an instruction form used in the first embodiment of the present invention;

FIG. 3 is a flowchart showing the operation of the first embodiment of the present invention;

FIG. 4 is a structural block diagram showing the operation of the first embodiment of the present invention;

FIG. 5 is a flowchart showing the operation of a modification of the first embodiment of the present invention;

FIG. 6 is a structural block diagram showing the operation of a modification of the first embodiment of the present invention;

FIG. 7 is a structural block diagram of an instruction form management system used in the second embodiment of the present invention;

FIG. 8 shows an instruction form used in the second embodiment of the present invention;

FIGS. 9A and 9B are flowcharts showing the operation of the second embodiment of the present invention;

FIG. 10 is a structural block diagram of an instruction form management system used in the third embodiment of the present invention;

FIG. 11 shows an instruction form used in the third embodiment of the present invention;

FIG. 12 shows an instruction form used in the third embodiment of the present invention; and

FIG. 13 is a flowchart showing the operation of the third embodiment of the present invention.

### DETAILED DESCRIPTION OF THE INVENTION

The present invention will be described in detail hereinafter with reference to the drawings.

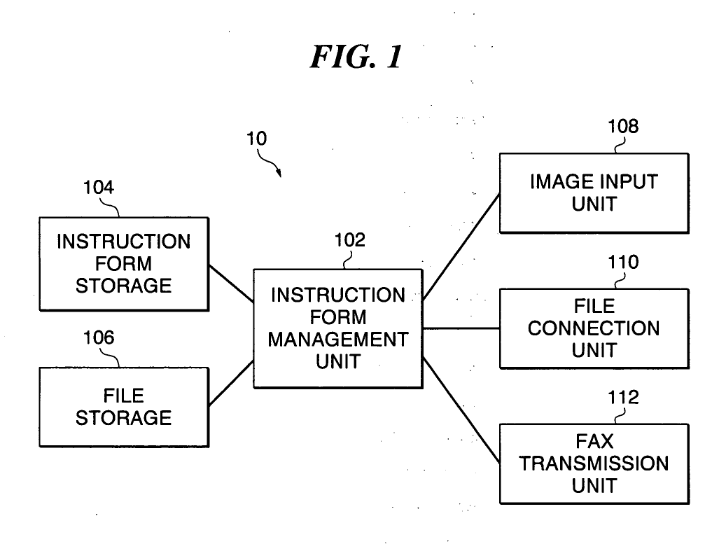

As shown in FIG. 1, an instruction form execution apparatus 10 in accordance with the first embodiment is provided with an instruction form storage 104 for storing an instruction form, a file storage 106 for storing a file, an image input unit 108 for inputting an image, a file connection unit 110 for connecting files, a FAX transmission unit 112 for FAX-transmitting of a file, and an instruction form management unit 102 for controlling these units and managing an instruction form, that includes an instruction form input part, instruction form deletion part, and instruction form determination part. The instruction form execution apparatus 10 may be, for example, a digital multifunction machine or a personal computer to which peripheral apparatus having an execution function are connected.

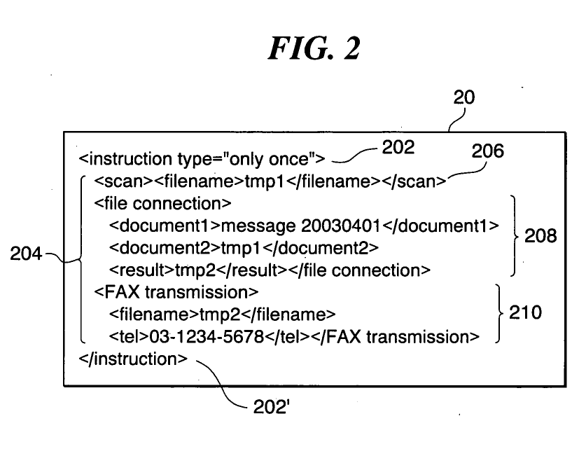

The instruction form is a document that indicates the processes to be executed by the image input unit 108, file connection unit 110, and FAX transmission unit 112 as shown exemplarily in FIG. 2. The instruction form 20 includes <instruction> 202 and </instruction> 202′ for indicating start and end of the instruction form and the process description 204 that indicates the execution instruction for indicating the process to be executed by the image input unit 108, file connection unit 110, and FAX transmission unit 112. The process description 204 includes a scan process description 206 interposed between <scan> and </scan> for indicating start and end of the process to be executed by the image input unit 108, a file connection processing description 208 interposed between <file connection> and </file connection> for indicating start and end of the process to be executed by the file connection unit 110, and a FAX transmission processing description 210 interposed between <FAX transmission> and </FAX transmission> for indicating start and end of the process to be executed by the FAX transmission unit 112.

The instruction form exemplified in FIG. 2 is described in XML (Extensible Markup Language), the present invention is by no means limited to XML. For example, the instruction form may be a paper medium having a thumbnail image for indicating the processing content and a checkbox, which paper medium is formed by marking a check mark on the checkbox that indicates the process to be executed by a user.

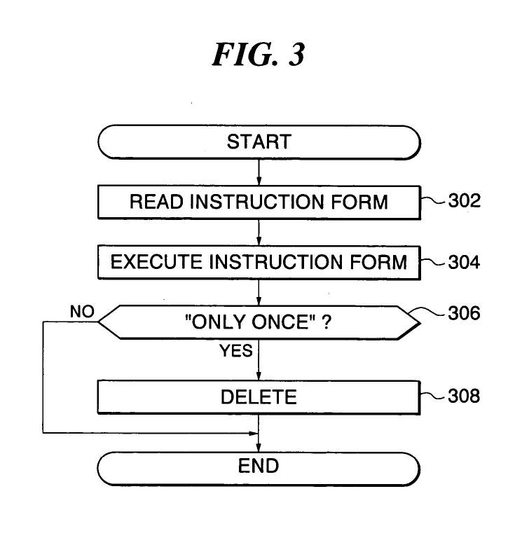

The operation of the first embodiment is described with reference to FIG. 3.

The instruction form 20 is formed by a user or system manager previously, and stored in the instruction form storage 104. When a user indicates the instruction form 20, the instruction form management unit 102 reads the instruction form 20 from the instruction form storage 104, analyzes the instruction form 20 at step 302. Then, the instruction form management unit 102 manages the execution of the process indicated in the instruction form 20 at step 304.

At step 306, the instruction form management unit 102 determines whether the instruction form 20 includes the information for deleting the instruction form or not. If the information for deleting the instruction form is included, the instruction form management unit 102 deletes the instruction form 20 from the instruction form storage 104 at step 308 and the sequence proceeds to the end. If the information for deleting the instruction form is not included, the sequence proceeds to the end without any processing.

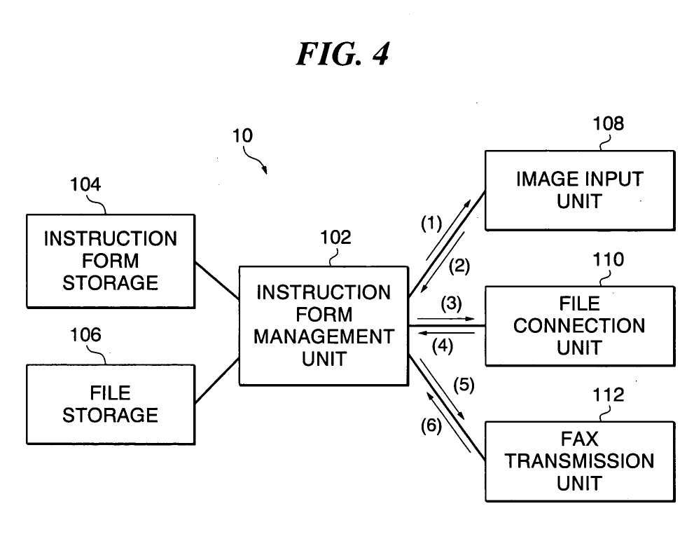

The process to be executed at step 304 when the instruction form 20 exemplarily shown in FIG. 2 is applied to the first embodiment is described in detail. As shown in FIG. 4, (1) the instruction form management unit 102 indicates that the image input unit 108 reads the manuscript based on the statement <filename> tmp1</filename> of the scan processing description 206. In other words, the instruction form management unit 102 gives the control function to the image input unit 108. It is assumed that the manuscript has been set previously in the image input unit 108 by a user, but if the manuscript has not been set, the apparatus 10 may be structured so as to prompt a user to set a manuscript. The image input unit 108 scans the manuscript and stores the scanned manuscript as a file having a name [tmp1] in the file storage 106. (2) The image input unit 108 returns the control function to the instruction form management unit 102.

Next, (3) the instruction form management unit 102 controls the file connection unit 110 to execute the process of the file connection processing description 208. In other words, the instruction form management unit 102 gives the control function to the file connection unit 110. The file connection unit 110 reads a file [message 20030401] and [tmp1] shown in the first statement <document1>message 20030401</document1> and second statement <document2>tmp1</document2> respectively from the file storage 106 to connect them, and stores it in the file storage 106 as a file [tmp2] shown in the third statement <result>tmp 2</result>. (4) The file connection unit 110 returns the control function to the instruction form management unit 102.

Finally, (5) the instruction form management unit 102 controls the FAX transmission unit 112 to execute the process of the FAX transmission processing description 210. In other words, the instruction form management unit 102 gives the control function to the FAX transmission unit 112. The FAX transmission unit 112 FAX-transmits the file [tmp 2] shown in the first statement <filename>tmp2</filename> to the telephone number [03-1234-5678] shown in the second statement <tel>03-1234-5678</tel>. (6) The FAX transmission unit 112 returns the control function to the instruction form management unit 102.

At step 306, whether the instruction form 20 includes the information for deleting the instruction form or not is determined. In detail, whether <instruction> 202 for indicating the start of the instruction form 20 includes or not [type=“only once”], that is the information for deleting the instruction form, as a deletion instruction is determined. <instruction> 202 of the instruction form 20 exemplified in FIG. 2 includes <type=“only once”>, hence the instruction form management unit 102 deletes the instruction form 20 from the instruction form storage 104 at step 308 and the sequence proceeds to the end.

As described hereinabove, the instruction form includes the processing description 204 that functions as an execution instruction to indicate the process to be executed by the instruction form execution apparatus 10 and includes the information ([type=“only once”]) for deleting the instruction form that functions as the deletion instruction. The deletion instruction indicates an instruction for deleting the instruction form 20 when the instruction form execution apparatus 10 completes the process indicated by the processing description 204. As described hereinabove, the instruction form in the embodiment is structured as the data structure, but in the present invention the instruction form is by no means limited to the abovementioned instruction form, and the execution instruction and deletion instruction are data and the instruction form may be of the data structure.

The information for deletion of the instruction form is [type=“once”] in the first embodiment, that is, the information is the information for indicating that the instruction indicates the process to be executed only once, however, the information to be used in the present invention is by no means limited to the abovementioned information. However, if the instruction form 20 that is to be executed only once remains in the instruction form storage 104, the tight memory capacity is reduced and the instruction form 20 can be executed again erroneously despite the execution once finished. It is a heavy burden on a user to manage to confirm the instruction form 20 that is to be executed only once and delete it as required. Therefore, it is very effective to reduce the burden on a user by setting the information to be executed only once as the information to be deleted.

As described hereinabove, the instruction form storage 104 inputs the instruction form 20 that indicates execution of the process, the image input unit 108, file connection unit 110, and FAX transmission unit 112 execute the process indicated in the instruction form 20, and the instruction form management unit 102 determines whether the instruction form 20 includes or not the information for deleting the instruction form in the instruction form 20 when the image input unit 108, file connection unit 110, and FAX transmission unit 112 complete execution of the process indicated in the instruction form 20. Then, the instruction form management unit 102 deletes the instruction form if the instruction form 20 includes the information for deleting the instruction form 20.

In other words, the instruction form input part inputs the instruction form that indicates execution of the process, and the execution part executes the process indicated in the instruction to complete execution of the process indicated in the instruction form. At that time, whether the information for deleting the instruction form is included or not in the instruction form is determined, and if the instruction form includes the information for deleting the instruction form, the instruction form deletion part deletes the instruction form. As the result, the instruction form is deleted only in the case that the instruction form includes the information for deleting the instruction form.

For example, by use of the information for deleting the instruction form that is the information to be executed only once, the problem that the instruction form to be used only once remains stored after execution to cause reduction of the memory capacity and erroneous repeated execution of the instruction form is avoided. The burden on a user to manage the instruction form is mitigated. An instruction form to be executed again can remain stored by deleting only the instruction form that includes the information for deleting the instruction form.

The image input unit 108, file connection unit 110, and FAX transmission unit 112 are described to execute the instruction form in FIG. 1 to FIG. 4 and the process that relates to these units is described hereinabove, however, the present invention is by no means limited the abovementioned units. For example, an image output unit, audio input/output unit, and personal computer (namely control unit for arithmetic calculation and image processing) may be used to execute the instruction form.

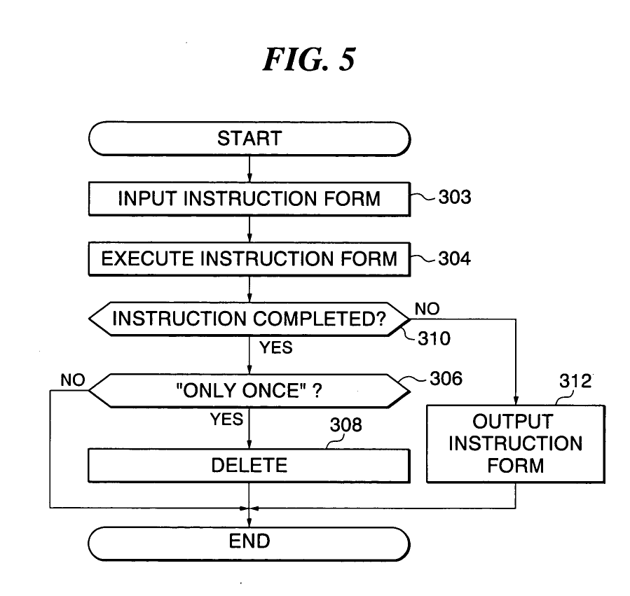

The operation of the modification 1 of the first embodiment will be described with reference to FIG. 5. The structure of the modification of the first embodiment is approximately the same as that of the first embodiment, the same elements as those of the first embodiment are given the same characters, and the description is omitted.

An instruction form 20 has been formed previously by a user or system manager, and stored in an instruction form storage 104. When a user specifies the instruction form 20 through a user interface, an instruction form management unit 102 reads the instruction form 20 from the instruction form storage 104 and analyzes the instruction form 20. The instruction form management unit 102 outputs the instruction form 20 to a first unit that is indicated in the instruction form 20 to execute the described process first.

At step 303, the first unit that is indicated to execute first inputs the instruction form 20 from the instruction form management unit 102. When the first unit executes the process indicated in the instruction form 20 at step 304, whether all the processes indicated in the instruction form 20 has been completed or not, namely whether the process to be executed by other units remain or not, is determined at step 310. If all the processes have not been completed, the first unit outputs the instruction form 20 at step 312. The output instruction form is input to the second unit that is indicated to execute second in the instruction form 20.

In detail, until the final unit that is indicated to finally execute inputs the instruction form 20, other units execute the processes at steps 303, 304, 310, and 312. When the final unit that is indicated to execute finally inputs the instruction form 20 at step 303, all the processes are determined to be completed at step 310. If all the processes are determined to be completed, whether the instruction form 20 includes the information for deleting the instruction form 20 or not is determined at step 306. If the instruction form 20 includes the information for deleting the instruction form 20, the instruction form management unit 102 deletes the instruction form 20 from the instruction form storage 104 at step 308, and all the processes are completed. On the other hand, if the instruction form 20 does not include the information for deleting the instruction form 20, the sequence proceeds to the end without any execution.

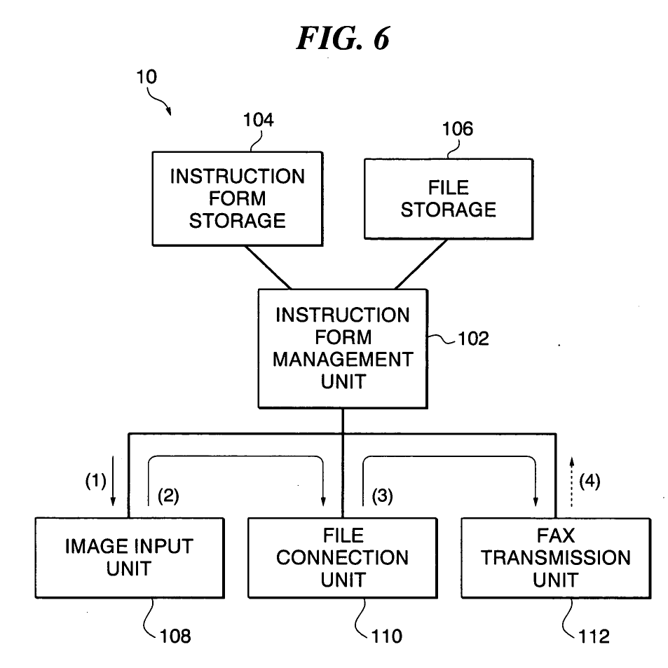

The process executed when the instruction form 20 exemplified in FIG. 2 is applied to the modification 1 of the first embodiment will be described in detail with reference to FIG. 6. (1) At step 303, the image input unit 108 inputs the instruction form 20 from the instruction form management unit 102. At step 304, the image input unit 108 analyzes a statement <filename>tmp1</filename> of the scan processing description 206, and reads the manuscript. It is assumed that the manuscript has been set previously in the image input unit 108 by a user, but if the manuscript has not been set, the apparatus 10 may be structured so as to prompt a user to set a manuscript. The image input unit 108 scans the manuscript and stores the scanned manuscript as a file having a name [tmp1] in a file storage 106. (2) At step 310, the image input unit 108 determines that the process indicated in the instruction form 20 has not been completed, or that the process to be executed by a file connection unit 110 next has not been indicated, and at step 312, outputs the instruction form 20 to the file connection unit 110.

At step 303, the file connection unit 110 inputs the instruction form 20 from the image input unit 108. At step 304, the file connection unit 110 analyzes the process of the file connection processing description 208 and executes it. In detail, the file connection unit 110 reads and connects [message 20030401] and [tmp1] shown in the first statement <document1>message 20030401</document1> and second statement <document2>tmp1</document2> from the file storage 106, and stores the resultant file [tmp2] shown in the third statement <result>tmp2</result> in the file storage 106. (3) At step 310, the file connection unit 110 determines that the process indicated in the instruction form 20 has not been completed, or that the process to be executed next by the FAX transmission unit 112 has been indicated, and then at step 312, outputs the instruction form 20 to the FAX transmission unit 112.

Finally, at step 303, the FAX transmission unit 112 inputs the instruction form 20 from the file connection unit 110. At step 304, the FAX transmission unit 112 analyzes and executes the process of the FAX transmission processing description 210. In detail, the FAX transmission unit 112 FAX-transmits the file [tmp2] shown in the first statement <filename>tmp2</filename> to a telephone number [03-1234-5678] shown in the second statement <tel>03-1234-5678</tel>. At step 310, the FAX transmission unit 112 determines that the process indicated in the instruction form 20 has been completed, or that the process to be executed by the next execution part is not indicated.

At step 306, whether the information for deleting the instruction form is included in the instruction form 20 or not is determined. In other words, it is determined whether or not [type=“only once”], namely the information for deleting the instruction form, is included in the <instruction> 202 that indicates the start of the instruction form 20. The FAX transmission unit 112 deletes the instruction form 20 from the instruction form storage 104 and all the processes are completed at step 308 because [type=“only once”] is included in the instruction form 20 exemplified in FIG. 2. Otherwise in the above, (4) the FAX transmission unit 112 may output the instruction form 20 to the instruction form management unit 102, and the instruction form management unit 102 deletes the instruction form 20 from the instruction form storage 104.

The structure of a modification 2 of the first embodiment will be described hereunder. In the modification 2, the instruction form execution apparatus 10 of the first embodiment and the modification 1 is structured as an instruction form management system. In detail, an image input unit 108, file connection unit 110, and FAX transmission unit 112 are independent instruction form execution apparatuses having an instruction form input part that inputs an instruction for indicating execution of the process, an execution part that executes the process indicated in the instruction form, and an instruction form deletion part that deletes the instruction form when the execution part completes the process indicated in the instruction form respectively. The instruction form execution apparatus may be provided with an instruction form determination part that determines whether or not the instruction form includes the information for deleting the instruction form when the execution part completes the execution of the process indicated in the instruction form.

The instruction form management unit 102 is an instruction form management apparatus having an input part that inputs the instruction form which indicates the process to be executed by at least one instruction form execution apparatus and an output part that outputs the instruction form to any one of the instruction form execution apparatuses.

The operation of the modification 2 is approximately the same as that of the first embodiment and the modification 1, and the description is omitted. In the modification 2, only the instruction form execution apparatus has the instruction form deletion part that deletes the instruction form.

The structure of the modification 3 of the first embodiment will be described hereunder. In the modification 3, the instruction form execution apparatus 10 of the first embodiment and the modification 1 is structured as an instruction form management system that is different from that described in the modification 2. In detail, the instruction form management unit 102 is an instruction form management apparatus having an input part that inputs the instruction form for indicating the process to be executed by at least one instruction form execution apparatus, an output part that outputs the instruction form to any one of the instruction form execution apparatus, and a deletion part that deletes the instruction form when the instruction form is input from any of the instruction form execution apparatuses by means of the input part and the process indicated in the instruction form has been completed.

The instruction form management apparatus may be provided with a determination part that determines whether the instruction form includes the information for deleting the instruction form or not when the instruction form execution apparatus completes the execution of the process indicated in the instruction form. The information for deleting the instruction form may be the information for suggesting that the instruction form indicates the process to be executed only once.

The image input unit 108, file connection unit 110, and FAX transmission unit 112 are the instruction form execution apparatus having an instruction form input part that inputs the instruction form output from the output part, an execution part that executes the process indicated in the instruction form, and an instruction form output part that outputs the instruction form when the execution of the process indicated in the instruction form is completed.

The operation of the modification 3 is approximately the same as that of the first embodiment and the modification 1, and the description is omitted. The modification 3 is different from the modification 2 in that only the instruction form management apparatus has the deletion part that deletes the instruction form in the modification 3.

The modification 4 of the first embodiment will be described hereunder. In the modification 4, the instruction form execution apparatus 10 of the first embodiment and the modification 1 is structured as an instruction form management system. In detail, the instruction form management unit 102 is an instruction form management apparatus having an input part that inputs the instruction form for indicating the process to be executed by at least one instruction form execution apparatus, an output part that outputs the instruction form to any one of the instruction form execution apparatuses, and a deletion part that deletes the instruction form when the instruction form is input from any of the instruction form execution apparatuses by means of the input part and the process indicated in the instruction form has been completed. The instruction form management apparatus may be provided with a determination part that determines whether the instruction form includes the information for deleting the instruction form or not when the instruction form execution apparatus completes the execution of the process indicated in the instruction form.

An image input unit 108, file connection unit 110, and FAX transmission unit 112 are independent instruction form execution apparatuses having an instruction form input part that inputs an instruction form for indicating execution of the process, an execution part that executes the process indicated in the instruction form, and an instruction form deletion part that deletes the instruction form when the execution part completes the process indicated in the instruction form respectively. The instruction form execution apparatus may be provided with an instruction form determination part that determines whether or not the instruction form includes the information for deleting the instruction form when the execution part completes the execution of the process indicated in the instruction form.

The operation of the modification 4 is approximately the same as that of the first embodiment and the modification 1, and the description is omitted. The modification 4 is different from the modifications 2 and 3 in that the instruction form execution apparatus has the instruction form deletion part that deletes the instruction form and the instruction form management apparatus has the deletion part that deletes the instruction form. In the modification 4, either of the instruction form deletion part and the deletion part may delete the instruction form.

The structure of the modification 5 of the first embodiment is the same as that of the first embodiment and modifications 1 to 4, and the description is omitted.

In the first embodiment and the modifications 1 to 4, whether the instruction form 20 includes the information for deleting the instruction form or not is not determined at step 306 shown in FIG. 3 or FIG. 5, and the instruction form is deleted when execution of the process indicated in the instruction form is completed.

In detail, the instruction form storage 104 inputs the instruction form 20 for indicating execution of the process, the image input unit 108, file connection unit 110, and FAX transmission unit 112 execute the process indicated in the instruction form 20, and the instruction form management unit 102 deletes the instruction form when the image input unit 108, file connection unit 110, and FAX transmission unit 112 complete the process indicated in the instruction form 20.

As described hereinabove, the instruction form input part inputs the instruction form for indicating execution of the process, the execution part executes the process indicated in the instruction form, and the instruction form deletion part deletes the instruction form when the execution part completes execution of the process indicated in the instruction form. As the result, the instruction form can be deleted when the process indicated in the instruction form is executed completely.

According to the technique described hereinabove, the instruction form that has been executed once can be deleted without inclusion of the information for deleting the instruction form in the instruction form. As the result, the problem can be avoided that involves reduction of the tight memory capacity and erroneous repeated execution of the instruction form that has been executed once due to storage of useless instruction form.

In other way, the instruction form 20 indicates execution of the process in plural instruction form execution apparatuses 10, and the instruction form deletion part, namely the instruction form management unit 102, deletes the instruction form 20 when the plural instruction form execution apparatuses 10 execute the process completely.

The second embodiment of the present invention will be described hereinafter with reference to the drawings.

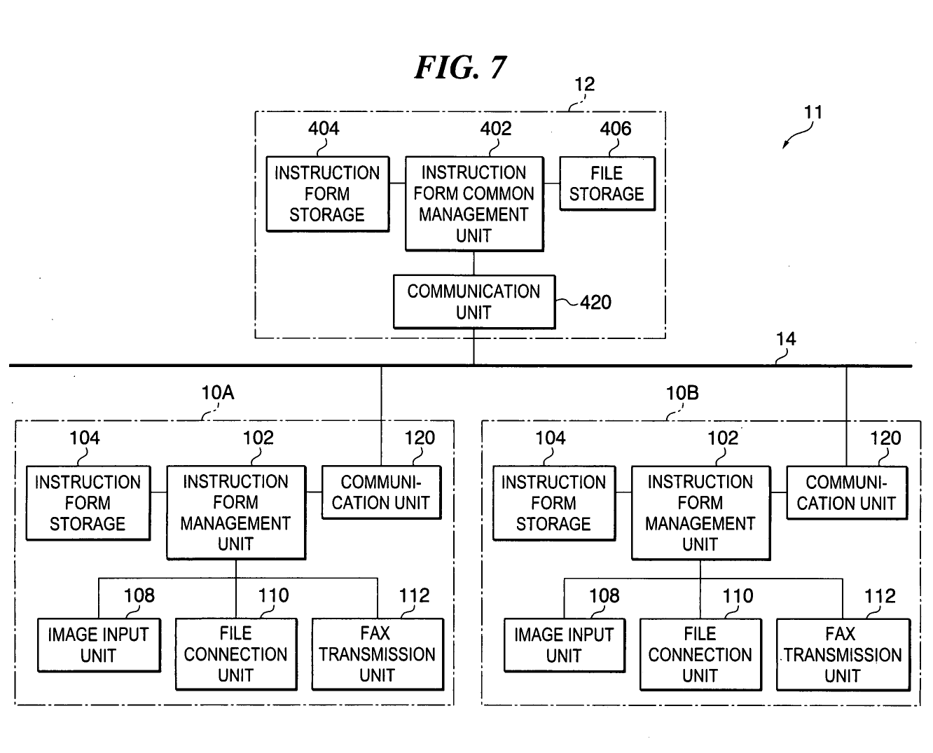

As shown in FIG. 7, an instruction form management system 11 is provided with plural instruction form execution apparatus 10 (10A and 10B) and an instruction form management apparatus 12.The plural instruction form execution apparatus 10 and the instruction form management apparatus 12 are connected through a network 14. The network 14 may be Internet or LAN, but that is by no means limited to them. For example, the network 14 may be a wireless connection such as Bluetooth.

The instruction form execution apparatus 10 is provided with instruction form storages 104 for storing an instruction form, image input units 108 for inputting an image, file connection units 110 for connecting files, FAX transmission units 112 for transmitting a file, communication units 120 for communicating with the network 14, and instruction management units 102 for controlling these units and managing the instruction form and deleting the instruction form.

The instruction form management apparatus 12 is provided with a instruction form storage 404 for storing the instruction form, a file storage 406 for storing a file, a communication unit 420 for communicating with the network 14, and an instruction form common management unit 402 for controlling these units and functioning as a copy part and as a deletion part that manage the instruction form used commonly in the instruction form management system 11.

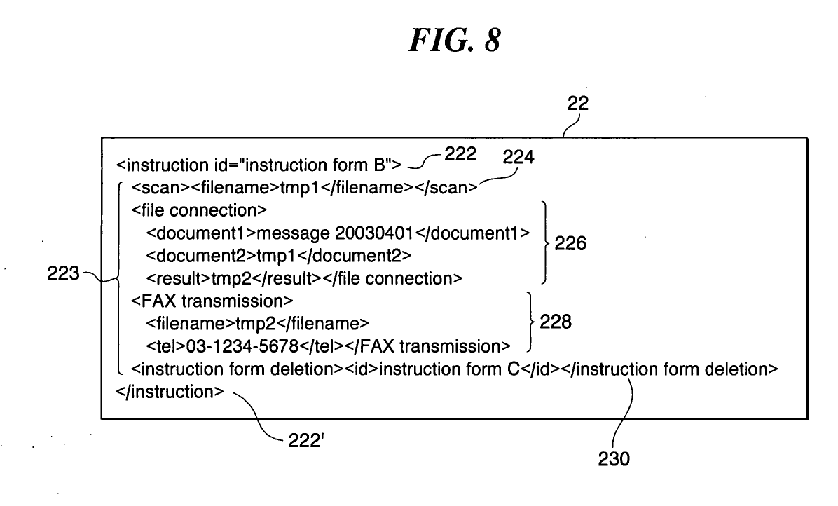

An instruction form that indicates the process to be executed by the image input unit 108, file connection unit 110, and FAX transmission unit 112 of the execution apparatus 10, is exemplarily shown in FIG. 8. The instruction form 22 includes <instruction> 222 and </instruction> 222′ that indicate start and end of the instruction form respectively. The processing unit 223 includes a scan processing description 224 interposed between <scan> and </scan> that indicate start and end of the process to be executed by the image input unit 108, a file connection processing description 226 interposed between <file connection> and </file connection> that indicate start and end of the process to be executed by the file connection unit 110, a FAX transmission processing description 228 interposed between <FAX transmission> and </FAX transmission> that indicate start and end of the process to be executed by the FAX transmission unit 112, and an instruction form deletion processing description 230 interposed between <instruction form deletion> and </instruction form deletion> that indicate the start and end of the process for deleting the instruction form.

The instruction form exemplified in FIG. 8 is described in XML (Extensible Markup Language), the present invention is by no means limited to XML. For example, the instruction form may be a paper medium having a thumbnail image for indicating the processing content and a checkbox, which paper medium is formed by marking a check mark on the checkbox that indicates the process to be executed by a user.

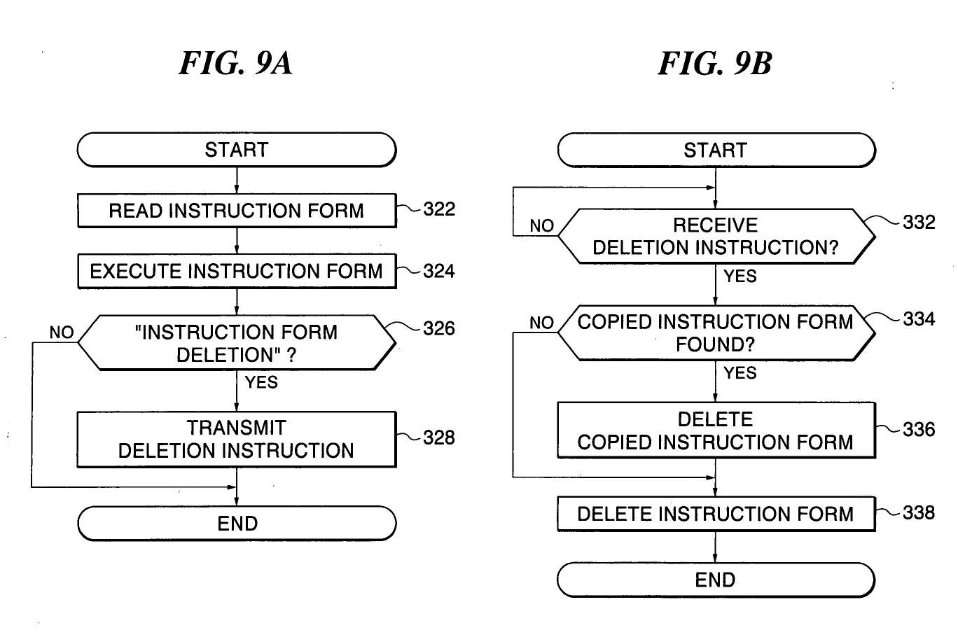

The operation of the second embodiment will be described with reference to FIG. 9A and FIG. 9B.

The instruction form 22 has been formed previously by a user or system manager, and stored in the instruction form storage 404 of the instruction form management apparatus. The instruction form 22 is copied in the instruction form common management unit 402 so as to be used by any of the instruction form execution apparatus 10A and 10B, transmitted to the instruction form execution apparatuses 10A and 10B through the communication unit 420, and stored as the copied instruction form in the instruction form storages 104.

When a user specifies the instruction form 22 of the instruction form execution apparatus 10A through a user interface, the instruction form management unit 102 of the instruction form execution apparatus 10A reads the instruction form 22 from the instruction form storage 104 and analyzes the instruction form 22 at step 322, and controls execution of the process indicated in the instruction form 22 at step 324.

At step 326, the instruction form management unit 102 determines whether or not the instruction form 22 includes the information for deleting the instruction form and the copied instruction form formed from the original instruction form. If the instruction form includes the information for deleting the instruction form and the copied instruction form, a deletion request for deleting the instruction form and the copied instruction form is transmitted to the instruction form management apparatus 12 at step 328, and the sequence proceeds to the end. On the other hand, if the instruction form does not include the information for deleting the instruction form and the copied instruction form, the sequence proceeds to the end without any processing.

When the instruction form common management unit 402 of the instruction form management apparatus 12 receives the deletion request at step 332, the instruction form common management unit 402 determines whether or not the instruction form execution apparatus 10B has a copy of the instruction form 80 at step 334. If the copied instruction form is stored in the instruction form execution apparatus 10B, the instruction form common management unit 402 deletes the copied instruction from at step 336. If the copied instruction form is stored in the instruction form storage 404 of the instruction form management apparatus 12, this instruction form is also deleted.

Alternatively, the instruction form common management unit 402 may transmit a request for deleting the copied instruction form to the instruction form execution apparatus 10B, and the instruction form management unit 102 of the instruction form execution apparatus 10B may delete the copied instruction form.

If the copied instruction form is not stored in the instruction form execution apparatus 10B, or after the copied instruction form is deleted at step 336, the instruction form common management unit 402 deletes the instruction form 22 stored in the instruction form storage 104 of the instruction form execution apparatus 10A. Alternatively, the instruction form common management unit 402 may transmit a request for deleting the instruction form 22 to the instruction form execution apparatus 10A, and the instruction form management unit 102 of the instruction form execution apparatus 10A may delete the instruction form 22.

For the purpose of simplicity, the system having two instruction form execution apparatuses 10A and 10B is described, but the present invention is by no means limited to the above, and a system may be employed in which three or more instruction form execution apparatus 10 are connected to the network 14 and copied instruction forms are stored respectively in three or more instruction form execution apparatuses 10.

The process of step 324 executed when the instruction form 22 exemplarily shown in FIG. 8 is applied to the second embodiment is described in detail. The instruction form management unit 102 indicates to the image input unit 108 to read the manuscript based on the statement <filename>tmp1</filename> of the scan processing description 224. In other words, the instruction form management unit 102 gives the control function to the image input unit 108. It is assumed that a user has set the manuscript previously in the image input unit 108, but if the manuscript has not been set in the image input unit 108, the apparatus 10 may be structured so as to prompt a user to set a manuscript. The image input unit 108 scans the manuscript and stores the scanned manuscript as a file having a name [tmp1] in the file storage 406. The image input unit 108 returns the control function to the instruction form management unit 102.

Next, the instruction form management unit 102 controls the file connection unit 110 to execute the process of the file connection processing description 226. In other words, the instruction form management unit 102 gives the control function to the file connection unit 110. The file connection unit 110 reads a file [message 20030401] and [tmp1] shown in the first statement <document1>message 20030401</document1> and second statement <document2>tmp1</document2> respectively from the file storage 406 to connect them, and stores it in the file storage 406 as a file [tmp2] shown in the third statement <result>tmp 2</result>. The file connection unit 110 returns the control function to the instruction form management unit 102.

Finally, the instruction form management unit 102 controls the FAX transmission unit 112 to execute the process of the FAX transmission processing description 228. In other words, the instruction form management unit 102 gives the control function to the FAX transmission unit 112. The FAX transmission unit 112 FAX-transmits the file [tmp2] shown in the first statement <filename>tmp2</filename> to the telephone number [03-1234-5678] shown in the second statement <tel>03-1234-5678</tel>. The FAX transmission unit 112 returns the control function to the instruction form management unit 102.

At step 326, whether the instruction form 22 includes the information for deleting the instruction form or not is determined. In other words, whether the instruction form 22 includes the instruction form deletion processing description 230 or not is determined. Because the instruction form 22 exemplarily shown in FIG. 8 includes the instruction form deletion processing description 230, the instruction form management unit 102 transmits the deletion request for deletion of the instruction form 22 and copied instruction form to the instruction form management apparatus 12 at step 328, and the sequence proceeds to the end. <instruction> 222 that indicates starting of the instruction form includes the information [id=“instruction form B”] and the instruction form deletion processing description 230 includes the statement <id>instruction form B</id>. All the copied instruction forms of the instruction form 80 include the information [id=“instruction form B”] in <instruction> 222, and the statement <id>instruction form B</id> indicates that all the instruction forms including the information [id=“instruction form B”] should be deleted. The instruction form common management unit 402 of the instruction form management unit 12 inquires whether the instruction form execution apparatus 10 connected through the network 14 has the copy of the instruction form 22 or not at step 334 based on the statements 222 and 230 to thereby determine existence of the copied instruction form of the instruction form 22.

However, the present invention is by no means limited to the above. Alternatively, the instruction form common management unit 402 may form the list of the instruction form execution apparatus 10 that stores the copy of the instruction form 22 previously when the copy of the instruction form 22 is formed, and determine whether there is the copied instruction form or not based on the list.

As described hereinabove, the instruction form common management unit 402 copies the instruction form 22 to form at least one copied instruction form, and the instruction form common management unit 402 or instruction form management unit 102 deletes all the copied instruction forms of the instruction form 22. In other words, because the copying part copies the instruction form to form at least one copied instruction form and the instruction form deletion part deletes all the copied instruction forms, all the copied instruction forms are deleted without any management by a user when any one of the copied instruction forms is executed.

According to the above, because every instruction form execution apparatus executes the same instruction form, plural copied instruction forms are formed, and all the copied instruction forms can be deleted when any one of the copied instruction forms is executed. The problem of tight memory capacity and repeated erroneous execution of the copied instruction form, which is caused from remaining copied instruction forms after execution of any one of the copied instruction forms that is to be executed only once, can be avoided by deleting all the copied instruction forms as described hereinabove. A burden on user for managing the instruction forms can be reduced.

The image input unit 108, file connection unit 110, and FAX transmission unit 112 are described to execute the instruction form, and the process that relates to these units are described in FIG. 7 to FIGS. 9, but the present invention is by no means limited to the above. For example, the image input unit, audio input/output unit, and personal computer (namely control unit for executing arithmetic calculation and image processing) may be used to execute the instruction form.

The first embodiment and the modifications of the first embodiment may be applied to the second embodiment. In detail, in the first embodiment and the modifications of the first embodiment, a copying part that copies at least one copy of the instruction form to form a copied instruction form is additionally provided, and the instruction form deletion part deletes all the copied instruction forms. Furthermore, the instruction form storage 404 and the file storage 406 may be connected to the instruction form management apparatus 12 through a network.

The third embodiment of the present invention will be described hereinafter with reference to the drawings.

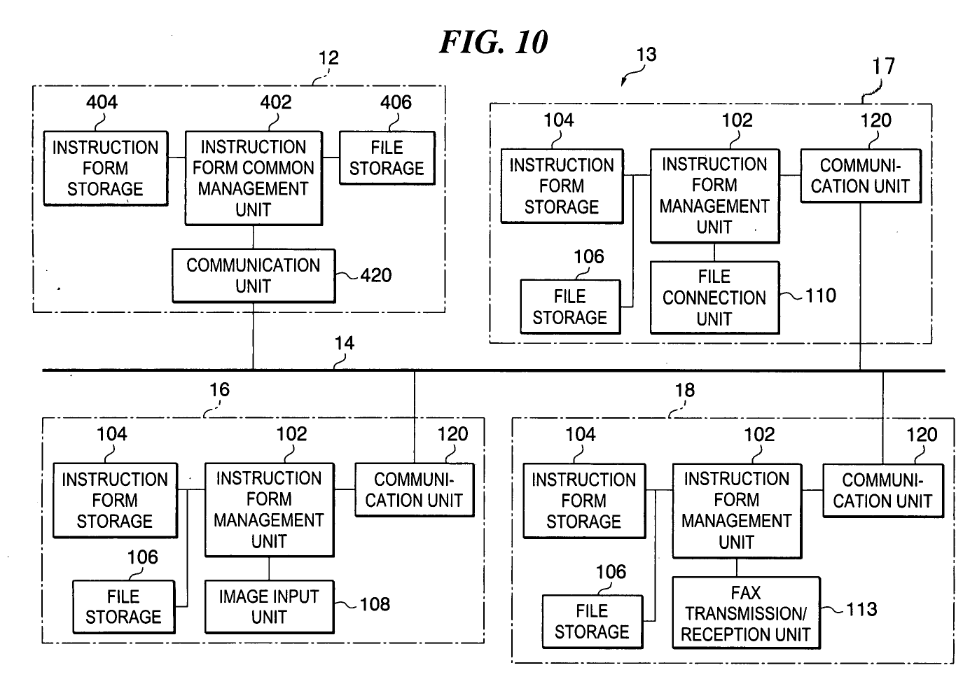

As shown in FIG. 10, the an instruction form management system 13 in accordance with the third embodiment includes instruction form execution apparatuses 16, 17, and 18, and an instruction form management apparatus 12. The instruction form execution apparatuses 16, 17, and 18 and the instruction form management apparatus 12 are connected through a network 14. The network 14 may be Internet or LAN, but is by no means limited to the above. For example, the network 14 may be a wireless connection such as Bluetooth.

The instruction form execution apparatus 16 is an image input apparatus having the instruction form storage 104 for storing an instruction form, file storage 106 for storing a file, image input unit 108 for inputting an image, communication unit 120 for communicating with the network 14, and instruction form management unit 102 for controlling these units and for managing the instruction form. The instruction form execution apparatus 17 is a file connection apparatus having a file connection unit 110 instead of the image input unit 108 of the instruction form execution apparatus 16. The instruction form execution apparatus 18 is a FAX transmission/reception apparatus having a FAX transmission/reception unit 113 instead of the image input unit 108 of the instruction form execution apparatus 16.

The instruction form management apparatus 12 is provided with the instruction form storage 404 for storing an instruction form, file storage 406 for storing a file, communication unit 420 for communicating with the network 14, and instruction form common management unit 402 that functions as a relation part and deletion part that controls and managing the instruction form used commonly in the instruction form management system 13.

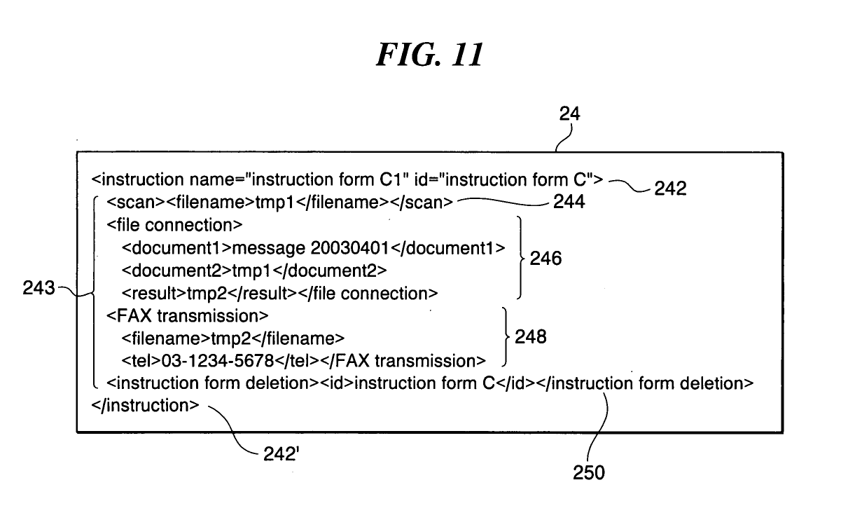

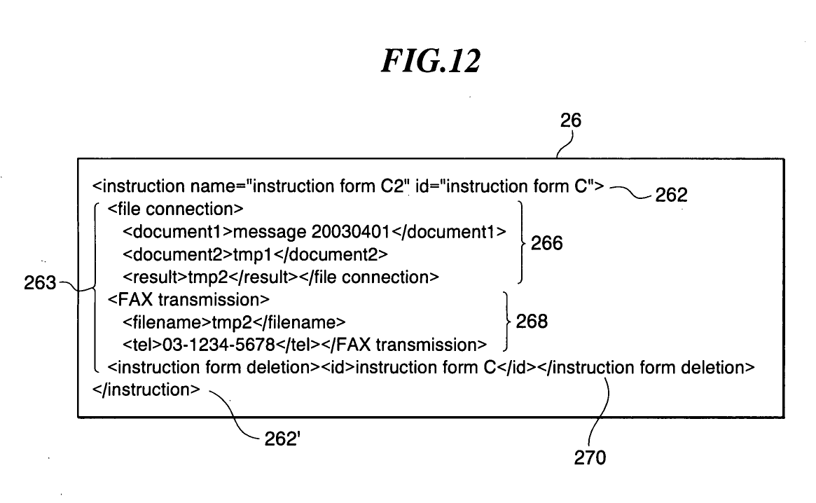

The instruction form in which the process to be executed by the instruction form execution apparatuses 16, 17, and 18 is described is shown exemplarily in FIG. 11 and FIG. 12. The instruction form 24 includes <instruction> 242 and </instruction> 242′ for indicating start and end of the instruction form respectively and the processing unit 243 for controlling the instruction form execution apparatuses 16, 17, and 18 to execute the process. The processing unit 243 includes a scan processing description 244 interposed between <scan> and </scan> for indicating start and end of the process to be executed by the instruction form execution apparatus 16 that is the image input apparatus, a file connection processing description 246 interposed between <file connection> and </file connection> for indicating start and end of the process to be executed by the instruction form execution apparatus 17 that is the file connection apparatus, a FAX transmission processing description 248 interposed between <FAX transmission> and </FAX transmission> for indicating start and end of the process to be executed by the instruction form execution apparatus 18 that is the FAX transmission/reception apparatus, and an instruction form deletion processing description 250 interposed between <instruction form deletion> and </instruction form deletion> for indicating start and end of the process for deleting the instruction form.

The instruction form 26 includes <instruction> 262 and </instruction> 262′ for indicating start and end of the instruction form respectively, and the processing unit 263 for indicating the process to be executed by the instruction form execution apparatuses 17 and 18. The processing unit 263 includes a file connection processing description 266 interposed between <file connection> and </file connection> for indicating start and end of the process to be executed by the instruction form execution apparatus 17 that is the file connection apparatus, a FAX transmission processing description 268 interposed between <FAX transmission> and </FAX transmission> for indicating start and end of the process to be executed by the instruction form execution apparatus 18 that is the FAX transmission/reception apparatus, and an instruction form deletion processing description 270 interposed between <instruction form deletion> and </instruction form deletion> for indicating start and end of the process for deleting the instruction form.

Both the instruction forms 24 and 26 include <id=“instruction form C”> in <instruction> 242 and <instruction> 262 respectively. In the third embodiment, the determination that the instruction forms 24 and 26 are the related instruction forms is made.

In the present invention, the related instruction form may be an instruction form that is related arbitrarily based on the determination of a user or system manager when the instruction form execution management unit 402 forms the instruction form. The instruction form common management unit 402 adds the same id as <id=“instruction form C”> in the statement for indicating start of the instruction form to thereby form the instruction form as the related instruction form.

As described hereinafter, the instruction form 24 indicates that the manuscript is to be stored as a reading file, the file is to be connected to another file, and the file is to be FAX-transmitted. The instruction form 26 indicates that a file stored already is to be connected to another file and the connected file is to be FAX-transmitted. In some cases, only the process in any one of the instruction forms 24 and 26 may be executed. For example, in the case that only the process indicated in the instruction form 24 is to be executed, if the instruction form 26 remains stored in the instruction form storage 404 after execution of the instruction form 24, the tight memory capacity is caused and the instruction form 26 is executed erroneously in spite of previous execution of the instruction form 24.

It is a heavy burden on a user to confirm and delete the instruction form 26 that becomes unnecessary to be executed. Therefore, the method, in which the instruction form that becomes unnecessary to be executed after execution of another instruction form is formed as a related instruction form and the related instruction form is deleted after execution of another instruction form, allows a user to be released from the burden.

The instruction form exemplified in FIG. 11 and FIG. 12 is described in XML (extensible Markup Language), the present invention is by no means limited to XML. For example, the instruction form may be a paper medium having a thumbnail image for indicating the processing content and a checkbox, which paper medium is formed by marking a check mark on the checkbox that indicates the process to be executed by a user.

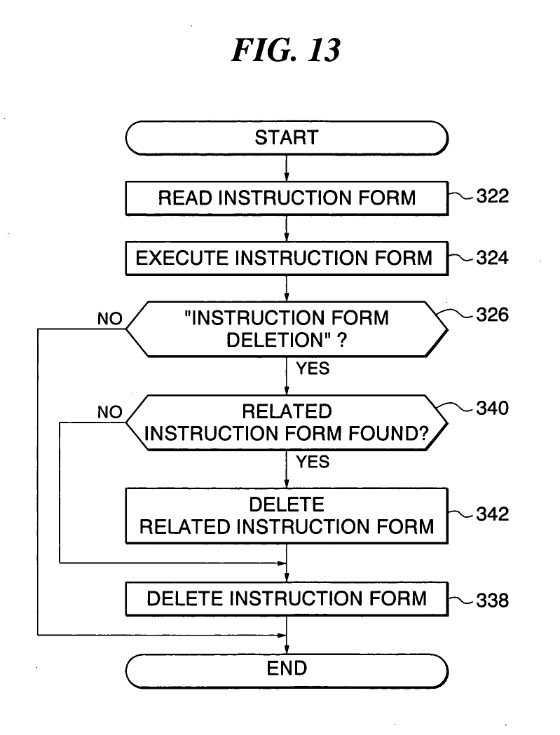

The operation of the third embodiment will be described with reference to FIG. 13.

The instruction forms 24 and 26 are formed previously by a user or system manager by means of the instruction form common management unit 402 of the instruction form management apparatus 12, and stored as the related instruction form in the instruction form storage 404.

When a user specifies the instruction form 24 stored in the instruction form storage 404 of the instruction form management apparatus 12 through the user interface, the instruction form common management unit 402 of the instruction form management apparatus 12 reads the instruction form 24 from the instruction form storage 404 and analyzes the instruction form 24 at step 322, and controls the instruction form execution apparatuses 16, 17, and 18 to execute the process indicated in the instruction form 24 at step 324.

At step 326, the instruction form common management unit 402 determines whether the instruction form 24 includes the information for deleting the instruction form and the related instruction form of the instruction form or not. If the instruction form 24 includes the information for deleting the instruction form and the related instruction form, the instruction form common management unit 402 determines whether the instruction form storage 404 stores the related instruction form relating to the instruction form 24 or not at step 340. If the instruction form storage 404 stores the instruction form 26 that is the related instruction form, the instruction form common management unit 402 deletes the instruction form 26 from the instruction form storage 404 at step 342.

If the instruction form storage 404 does not store the related instruction form, or after the instruction form 26 that is the related instruction form is deleted at step 342, the instruction form common management unit 402 deletes the instruction form 24 stored in the instruction form storage 404 at step 338.

For the purpose of easy description, the system having two instruction forms 24 and 26 is described, but the present invention is by no means limited to the above, and the system in which three or more related instruction forms are involved may be employed.

The process to be executed at step 324 of the third embodiment to which the instruction form 24 shown exemplarily in FIG. 11 is applied is described in detail. The instruction form common management unit 402 indicates to the instruction form execution apparatus 16 that is the image input unit to read the manuscript based on the statement <filename>tmp1</filename> of the scan processing description 244. In other words, the instruction form common management unit 402 gives the control function to the instruction form execution apparatus 16. It is assumed that the manuscript has been set previously in the instruction form execution apparatus 16 by a user, but if the manuscript has not been set, a user may be prompted to set a manuscript. The instruction form execution apparatus 16 scans the manuscript and stores the scanned manuscript as a file having a name [tmp1] in the file storage 406. The instruction form execution apparatus 16 returns the control function to the instruction form common management unit 402.

Next, the instruction form common management unit 402 controls the instruction form execution apparatus 17 that is a file connection apparatus to execute the file connection description 246. In other words, the instruction form common management unit 402 gives the control function to the instruction form execution apparatus 17. The instruction form execution apparatus 17 reads the files [message 20030401] and [tmp1] shown in the first statement <document 1>message 20030401</document 1> and the second statement <document 2>tmp1</document 2> respectively from the file storage 406 and connects them, and stores it as the file [tmp2] shown in the third statement <result>tmp2</result> in the file storage 406. The instruction form execution apparatus 17 returns the control function to the instruction form common management unit 402.

Finally, the instruction form common management unit 402 controls the instruction form execution apparatus 18 that is a FAX transmission/reception apparatus to execute the process of the FAX transmission processing description 248. In other words, the instruction form common management unit 402 gives the control function to the instruction form execution apparatus 18. The instruction form execution apparatus 18 FAX-transmits the file [tmp2] shown in the first statement <filename>tmp2</filename> to the telephone number [03-1234-5678] shown in the second statement <tel>03-1234-5678</tel>. The instruction form execution apparatus 18 returns the control function to the instruction form common management unit 402.

At step 326, whether the instruction form 24 includes the information for deleting the related instruction form or not is determined. In other words, whether the instruction form 24 includes the instruction form deletion processing description 250 or not is determined. Because the instruction form 24 exemplified in FIG. 11 includes the instruction form deletion processing description 250, whether the instruction form storage 404 stores the related instruction form that relates to the instruction form 24 or not is determined at step 340.

<instruction> 242 for indicating start of the instruction form 24 includes the information [name=“instruction form C1” id=“instruction form C”], and the instruction form deletion processing description 250 includes the statement <id> instruction form C</id>. All the related instruction forms of the instruction form 24 include the information [id=“instruction form C”] in the statement for indicating start of the instruction form, and the statement <id> instruction form C</id> of the instruction form deletion processing description 250 indicates that instruction forms including the information [id=“instruction form C”], namely all the related instruction forms, should be deleted. At step 340, the instruction form common management unit 402 of the instruction form management apparatus 12 determines whether the instruction form storage 404 stores the related instruction form or not based on the statements 242 and 250 of the instruction form 24.

On the other hand, if the instruction form 26 is specified by a user and executed, the instruction form common management unit 402 controls the instruction form execution apparatus 17 that is the file connection apparatus to execute the process of the file connection processing description 266. In other words, the instruction form common management unit 402 gives the control function to the instruction form execution apparatus 17. The instruction form execution apparatus 17 reads the files [message 20030401] and [tmp1] shown in the first statement <document 1>message 20030401</document 1> and the second statement <document 2>tmp2</document 2> respectively from the file storage 406 and connects them, and stores the connected file as the file [tmp2] shown in the third statement <result>tmp2</result> in the file storage 406. The instruction form execution apparatus 17 returns the control function to the instruction form common management unit 402.

Finally, the instruction form common management unit 402 controls the instruction form execution apparatus 18 that is the FAX transmission/reception apparatus to execute the process of the FAX transmission processing description 268. In detail, the instruction form common management unit 402 gives the control function to the instruction form execution apparatus 18. The instruction form execution apparatus 18 FAX-transmits the file [tmp2] shown in the first statement <filename>tmp2</filename> to the telephone number [03-1234-5678] shown in the second statement <tel>03-1234-5678</tel>. The instruction form execution apparatus 18 returns the control function to the instruction form common management unit 402.

According to the user or system manager determination that the process indicated in the instruction form 26 is not necessary to be executed if the instruction form 24 is executed, the instruction form 26 is formed as the related instruction form of the instruction form 24. In other words, <instruction> 262 for indicating start of the instruction form 26 includes the information [name=“instruction form C2” id=“instruction form C”]. Hence, the instruction form 26 is determined to be the related instruction form of the instruction form 24 at step 340, and deleted at step 342.

In the present invention, the method of determination is by no means limited to the method for determining whether the instruction form is the related instruction form or not based on id shown in the statement for indicating start of the instruction form. Alternatively, the instruction form common management unit 402 may form a related instruction form list of the instruction form 24 previously when the related instruction form of the instruction form 24 is formed, and whether the instruction form is the related instruction form or not may be determined based on the related instruction form list.

As described hereinabove, the instruction form common management unit 402 forms at least one related instruction form 26 that relates to the instruction form 24, and the instruction form common management unit 402 or instruction form management unit 102 deletes all the related instruction forms. Because the relation part forms at least one related instruction form that relates to the instruction form and the instruction form deletion part deletes all the related instruction forms, all the related instruction forms are deleted when any one of related instruction forms is executed without any user management.

According to the above, plural related instruction forms any one of which is to be executed later have been formed, and all the related instruction forms can be deleted when any one of the related instruction forms is executed selectively. As described hereinabove, the problem of the tight memory capacity and erroneous execution of the related instruction form due to remaining related instruction form in the memory can be avoided after execution of any one of the related instruction forms any one of which is necessary to be executed. Furthermore, the burden for a user to manage these related instruction forms is reduced.

In FIG. 10 to FIG. 13, the image input apparatus, file connection apparatus, and FAX transmission/reception apparatus are described as the instruction form execution apparatuses 16, 17, and 18 and the process that relates to these apparatuses is described, however, the present invention is by no means limited to the above. For example, an image input apparatus, audio input/output apparatus, and personal computer (namely control apparatus for executing arithmetic calculation and image processing) may be employed as the instruction form execution apparatus.

The first embodiment, modifications of the first embodiment, and second embodiment may be applied to the third embodiment. In detail, a relation part that forms at least one related instruction form that relates to the instruction form is added to the modifications of the first embodiment and the second embodiment, and the instruction form deletion part deletes all the related instruction forms. The instruction form storage 404 of the instruction form management apparatus 12 stores the instruction form and the related instruction form in the third embodiment, however, the present invention is by no means limited to the above, and the instruction form storage 104 of the instruction form execution apparatuses 16, 17, and 18 may store the instruction form and the related instruction form. Furthermore, the instruction form storage 404 and the file storage 406 may be connected to the instruction form management apparatus 12 through a network.

As described hereinabove, according to the present invention, the instruction form input part of the instruction form execution apparatus inputs an instruction for indicating execution of the process, the execution part executes the process indicated in the instruction, and the instruction form deletion part deletes the instruction form when the execution part completes execution of the process indicated in the instruction form. As the result, the instruction form is deleted when execution of the process indicated in the instruction form is completed.

The entire disclosure of Japanese Patent Application No. 2003-081198 filed on Mar. 24, 2003 including specification, claims, drawings and abstract is incorporated herein by reference in its entirety.

What is claimed is:

1. An instruction form execution apparatus comprising:
an instruction form input part that inputs an instruction form to indicate execution of a process;
an execution part that executes the process indicated in the instruction form; and
a deletion part that deletes the instruction form when the execution part completes the execution of the process indicated in the instruction form.

2. The instruction form execution apparatus according to claim 1, wherein the instruction form indicates execution of the process in plural instruction form execution apparatuses, and the deletion part deletes the instruction form when the execution of the process is completed in the plural instruction form execution apparatuses.

3. The instruction form execution apparatus according to claim 1, further comprising an instruction form determination part that determines whether or not the instruction form includes information to delete the instruction form when the execution part completes the execution of the instruction indicated in the instruction form, wherein the deletion part deletes the instruction form if the instruction form includes the information to delete the instruction form.

4. The instruction form execution apparatus according to claim 3, wherein the information that indicates deletion of the instruction form indicates that the instruction form is executed only once.

5. An instruction form management apparatus comprising:
an input part that inputs an instruction form that indicates a process to be executed by at least one of a plurality of instruction form execution apparatus;
an output part that outputs the instruction form to any one of the plurality of instruction form execution apparatuses; and
a deletion part that deletes the instruction form when the instruction form is input from any one of the plurality of instruction form execution apparatuses by the input part and the process indicated in the instruction form has been completed.

6. The instruction form management apparatus according to claim 5, further comprising a determination part that determines whether or not the instruction form includes information to delete the instruction form when the at least one of the instruction form execution apparatuses completes execution of the process indicated in the instruction form, wherein the deletion part deletes the instruction form if the instruction form includes the information to delete the instruction form.

7. The instruction form management apparatus according to claim 6, wherein the information to delete the instruction form indicates that the instruction form is executed only once.

8. An instruction form management system comprising:
at least one instruction form execution apparatus that comprises an instruction form input part that inputs an instruction form to indicate execution of a process, an execution part that executes the process indicated in the instruction form, and a deletion part that deletes the instruction form when the execution part completes the execution of the process indicated in the instruction form; and
an instruction form management apparatus,
wherein the instruction form management apparatus comprises an input part that inputs an instruction form that indicates a process to be executed by the at least one instruction form execution apparatus, and an output part that outputs the instruction form to the at least one instruction form execution apparatus.

9. The instruction form management system according to claim 8, further comprising a copying part that forms at least one copied instruction form by copying the instruction form, wherein the deletion part deletes all the copied instruction forms.

10. The instruction form management system according to claim 8, further comprising a relation part that forms at least one related instruction form that relates to the instruction form, wherein the deletion part deletes all the related instruction forms.

11. An instruction form management system comprising:
an instruction form management apparatus that comprises an input part that inputs an instruction form that indicates a process to be executed by at least one of a plurality of instruction form execution apparatus, an output part that outputs the instruction form to any one of the plurality of instruction form execution apparatuses, and a deletion part that deletes the instruction form when the instruction form is input from any one of the plurality of instruction form execution apparatuses by the input part and the process indicated in the instruction form has been completed; and
an instruction form execution apparatus that comprises an instruction form input part that inputs the instruction form output from the output part, an execution part that executes an instruction indicated in the instruction form, and an instruction form output part that outputs the instruction form when execution of the instruction indicated in the instruction form is completed.

12. The instruction form management system according to claim 11, further comprising a copying part that forms at least one copied instruction form by copying the instruction form, wherein the deletion part deletes all the copied instruction forms.

13. The instruction form management system according to claim 11, further comprising a relation part that forms at least one related instruction form that relates to the instruction form, wherein the deletion part deletes all the related instruction forms.

14. An instruction form management system comprising:
an instruction form execution apparatus that comprises an instruction form input part that inputs an instruction form to indicate execution of a process, an execution part that executes the process indicated in the instruction form, and a deletion part that deletes the instruction form when the execution part completes the execution of the process indicated in the instruction form; and
an instruction form management apparatus that comprises an input part that inputs an instruction form that indicates a process to be executed by at least one of a plurality of instruction form execution apparatus, an output part that outputs the instruction form to any one of the plurality of instruction form execution apparatuses, and a deletion part that deletes the instruction form when the instruction form is input from any one of the plurality of instruction form execution apparatuses by the input part and the process indicated in the instruction form has been completed.

15. The instruction form management system according to claim 14, further comprising a copying part that forms at lest one copied instruction form by copying the instruction form, wherein at least one of the deletion part and the instruction form deletion part deletes all the copied instruction forms.

16. The instruction form management system according to claim 14, further comprising a relation part that forms at least one related instruction form that relates to the instruction form, wherein at least one of the deletion part and the instruction form deletion part deletes all the related instruction forms.

17. An instruction form having an execution instruction that indicates a process to be executed by an instruction form execution apparatus and a deletion instruction, wherein the deletion instruction indicates an instruction to delete the instruction form when the execution of the process indicated in the execution instruction is completed by the instruction form execution apparatus.

18. The instruction form according to claim 17, wherein each of the execution instruction and the deletion instruction is a piece of data, and the instruction form is a data structure.

19. An instruction form execution method comprising:
inputting an instruction form that indicates execution of a process,
executing the process indicated in the instruction form, and
deleting the instruction form when the execution of the process indicated in the instruction form is completed.
